(19) United States
(12) Patent Application Publication
(10) Pub. No.: US 2020/0378172 A1
(43) Pub. Date: Dec. 3, 2020

(54) AN ENTRANCE SYSTEM HAVING ONE OR MORE MOVABLE DOOR MEMBERS AND AN INTELLIGENT GLASS PANEL

(71) Applicant: ASSA ABLOY ENTRANCE SYSTEMS AB, LANDSKRONA (SE)

(72) Inventor: Patrik LERPARD, Limhamn (SE)

(21) Appl. No.: 16/636,573

(22) PCT Filed: Aug. 15, 2018
(86) PCT No.: PCT/EP2018/072089

§ 371 Date: Feb. 4, 2020

(30) Foreign Application Priority Data
Aug. 17, 2017 (SE) 1730216-7

(51) Int. Cl. E05F 15/73

(52) U.S. Cl. CPC E05F 15/73; E05Y 2400/45; E05F 15/603; E05Y 2900/132; E05Y 2400/44; E05Y 2400/86

(57) ABSTRACT

An entrance system (10) comprising one or more movable door members (D1 . . . Dm), a support structure (16) for supporting the one or more door members (D1 . . . Dm) for movements between closed and open positions, an automatic door operator (30) for causing the movements of the one or more movable door members (D1 . . . Dm) between the closed and open positions is provided. The entrance system further comprises a control arrangement (20) comprising a controller (32) configured to control operation of the ON automatic door operator (30). The control arrangement (20) further comprises an intelligent glass panel (70), the intelligent glass panel being integrated with any of the movable door members (D1 . . . Dm) or the support structure (16), being operatively connected with the controller (32) and being configured to act as a user interface to the entrance system (10) for a human user.

### TECHNICAL FIELD

The present invention relates to the technical field of entrance systems having one or more movable door members. More specifically, the present invention relates to an entrance system having one or more movable door members, a support structure for supporting the one or more door members for movements between closed and open positions, an automatic door operator for causing movements of the one or more movable door members between closed and open positions, and a control arrangement configured to control operation of the automatic door operator.

### BACKGROUND

Entrance systems having automatic door operators are frequently used for providing automatic opening and closing of one or more movable door members in order to facilitate entrance and exit to buildings, rooms and other areas. The door members may for instance be swing doors, sliding door or revolving doors.

Entrance systems having automatic door operators are typically used in public areas during long periods of time and under varying conditions in terms of time of day (e.g. opening hours), time of week (e.g. work days or holidays), time of year (e.g. seasonal variations), passage frequencies, etc. To this end, entrance systems typically have a plurality of different operating modes in which the automatic door operators may be operated. Examples of different operating modes are, without limitation or prejudice, automatic operation, exit operation, forced open operation, forced closed operation, lock door operation, manual operation and summer position operation.

Conventionally, an operator panel is provided at the entrance system, typically in the form of a separate box which is installed next to the movable door members. A human operator may set the current operating mode by pressing a button on the operator panel.

However, the present inventors have identified problems and shortcomings in this respect. Prior art operator panel boxes require space, are prone to environmental wear and tear and are hard to keep clean and appealing. Additionally, in some public areas, it may be difficult to install an operator panel box properly because of space constraints or the surface materials of the public area in question. Accordingly, there is room for improvements in this field.

### SUMMARY

An object of the present invention is therefore to provide one or more improvements in the field of entrance systems having automatic door operators for causing movements of one or more movable door members between closed and open positions.

Accordingly, a first aspect of the present invention is an entrance system. The entrance system comprises one or more movable door members, a support structure for supporting the one or more door members for movements between closed and open positions, an automatic door operator for causing the movements of the one or more movable door members between the closed and open positions, and a control arrangement comprising a controller configured to control operation of the automatic door operator. The entrance system is characterized in that the control arrangement further comprises an intelligent glass panel, the intelligent glass panel being integrated with any of the movable door members or the support structure, being operatively connected with the controller and being configured to act as a user interface to the entrance system for a human user.

The provision of such a control arrangement will solve or at least mitigate one or more of the problems or drawbacks identified in the above, as will be clear from the following detailed description section and the drawings.

The intelligent glass panel may comprise input means configured for detecting touch actuation on a surface of the intelligent glass panel by the user and in response producing input data, output means configured for causing presentation of output data in the intelligent glass panel, and a first interface unit configured for communicating the input data produced by the input means to the controller and for receiving from the controller the output data to be presented by the output means.

In one embodiment the control arrangement further comprises a second interface unit coupled to the controller and adapted for communication with to the first interface unit of the intelligent glass panel, wherein the second interface unit is configured to receive from the first interface unit the input data produced by the input means of the intelligent glass panel, and to transfer said input data to the controller. The second interface unit may be configured to receive from the controller the output data to be presented by the output means of the intelligent glass panel, and to transfer said output data to the first interface unit of the intelligent glass panel.

The first and second interface units may be configured to operate in accordance with one or more short-range wireless data communication standards.

In one embodiment the intelligent glass panel comprises a touch-sensitive screen adapted to act both as said input means and as said output means. Preferably, the touch-sensitive screen is transparent. The touch-sensitive screen may comprise a liquid crystal display panel configured to selectively render the intelligent glass panel transparent.

In one embodiment the input means of the intelligent glass panel is configured for producing input data representing one or more of the following: a choice of a selected operating mode in which the automatic door operator shall operate, a setting of an operational parameter of the automatic door operator, a reset of an alarm triggered or detected by the automatic door operator, and a passcode required to execute any of the above.

The output means of the intelligent glass panel may be configured for presenting output data representing one or more of the following: an operational status of the automatic door operator, operational statistics of the entrance system, an indication of a need for maintenance of repair, an indication of an alarm triggered or detected by the automatic door operator, information assisting the user for inputting any of the input data referred to above, confirmation of a selected operating mode in which the automatic door operator shall operate, confirmation of a setting of an operational parameter of the automatic door operator, and confirmation of a reset of an alarm triggered or detected by the automatic door operator.

In one embodiment the intelligent glass panel is integrated with a glass window in any of the movable door members.

In an alternative embodiment the intelligent glass panel is integrated with a glass window in the support structure.

In different embodiments, the one or more movable door members may, for instance, be swing door members, sliding door members, revolving door members, sectional door members or pull-up door members.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings.

FIG. 1 is a schematic block diagram of an entrance system generally according to the present invention.

FIG. 2 is a schematic block diagram of an automatic door operator which may be included in the entrance system shown in FIG. 1.

FIG. 3A is a schematic top view of an entrance system according to a first embodiment, in the form of a sliding door system.

FIG. 3B is a schematic top view of an entrance system according to a second embodiment, in the form of a swing door system.

FIG. 3C is a schematic top view of an entrance system according to a third embodiment, in the form of a revolving door system.

FIG. 4A is a schematic view of an entrance system with a control arrangement according to a first embodiment.

FIG. 4B illustrates an entrance system with a control arrangement according to a second embodiment.

FIG. 4C illustrates an entrance system with a control arrangement according to a third embodiment.

FIG. 4D illustrates an entrance system with a control arrangement according to a fourth embodiment.

FIG. 4E illustrates an entrance system with a control arrangement according to a fifth embodiment.

FIG. 4F illustrates an entrance system with a control arrangement according to a sixth embodiment.

FIG. 4G illustrates an entrance system with a control arrangement according to a seventh embodiment.

FIG. 5A is a schematic block diagram of a control arrangement of an entrance system according to a first embodiment.

FIG. 5B is a schematic block diagram of a control arrangement of an entrance system according a second embodiment.

FIG. 6A is a schematic view of an intelligent glass panel in an entrance system according to one embodiment.

FIG. 6B is a schematic view of an intelligent glass panel in an entrance system according to one embodiment.

FIG. 7 is a flowchart diagram illustrating a method of operating an entrance system according to an embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

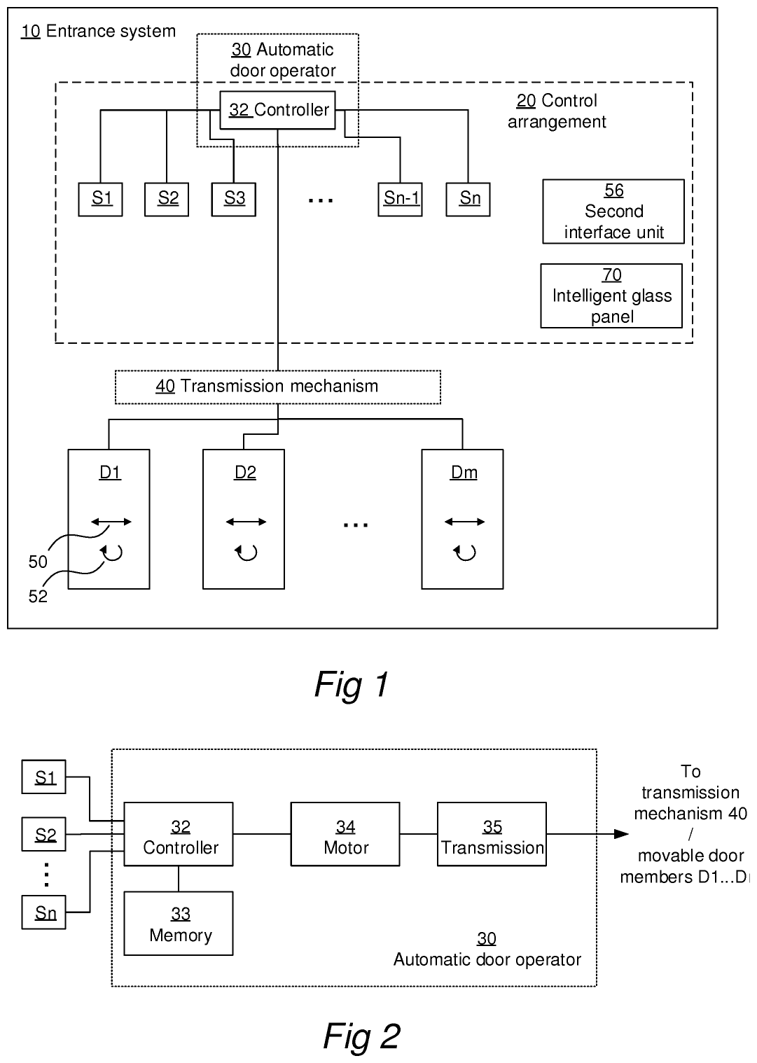

FIG. 1 is a schematic block diagram illustrating an entrance system 10 in which the inventive aspect of the present invention may be applied. The entrance system 10 comprises one or more movable door members D1 . . . Dm, and an automatic door operator 30 for causing movements of the door members D1 . . . Dm between closed and open positions. In FIG. 1, a transmission mechanism 40 conveys mechanical power from the automatic door operator 30 to the movable door members D1 . . . Dm. FIG. 2 illustrates one embodiment of the automatic door operator 30 in more detail.

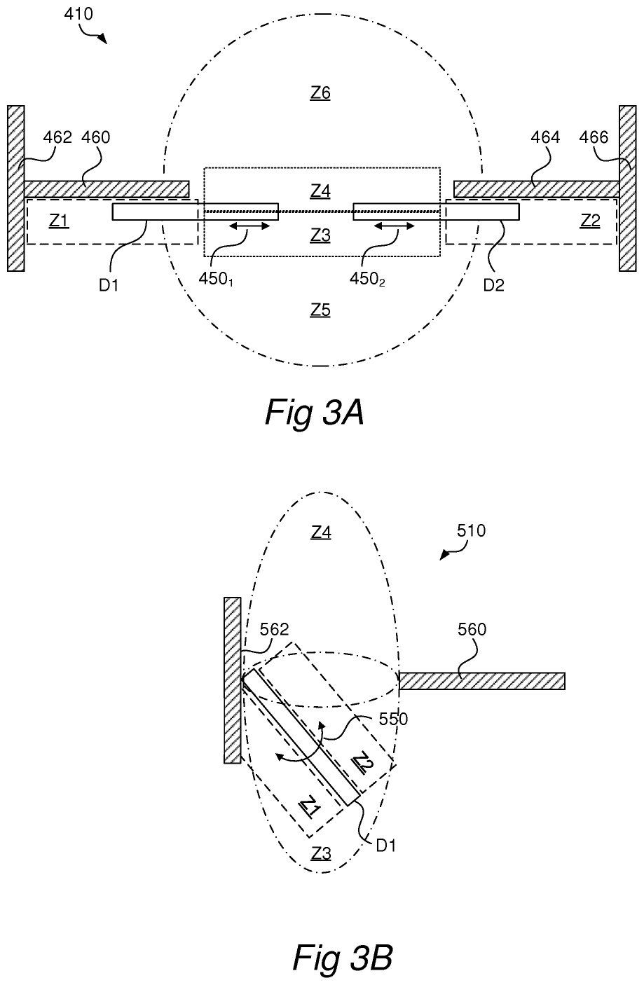

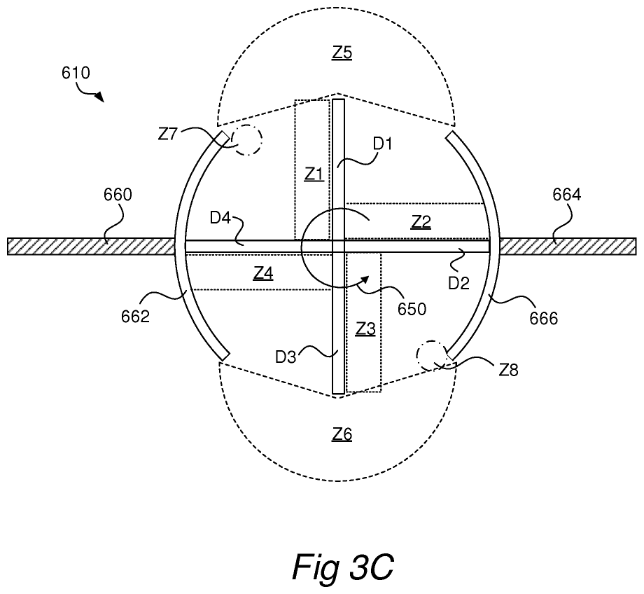

A control arrangement 20 is provided for the entrance system 10. The control arrangement 20 comprises a controller 32, which may be part of the automatic door operator 30 as seen in the embodiment of FIG. 2, but which may be a separate device in other embodiments. The control arrangement 20 also comprises a plurality of sensors S1 . . . Sn. Each sensor is connected to the controller 32 by wired connections, wireless connections, or any combination thereof. As will be exemplified in the subsequent description of the three different embodiments in FIGS. 3A, 3B and 3C, each sensor is configured to monitor a respective zone Z1 . . . Zn at the entrance system 10 for presence or activity of a person or object. The person may be an individual who is present at the entrance system 10, is approaching it or is departing from it. The object may, for instance, be an animal or an article in the vicinity of the entrance system 10, for instance brought by the aforementioned individual. Alternatively, the object may be a vehicle or a robot.

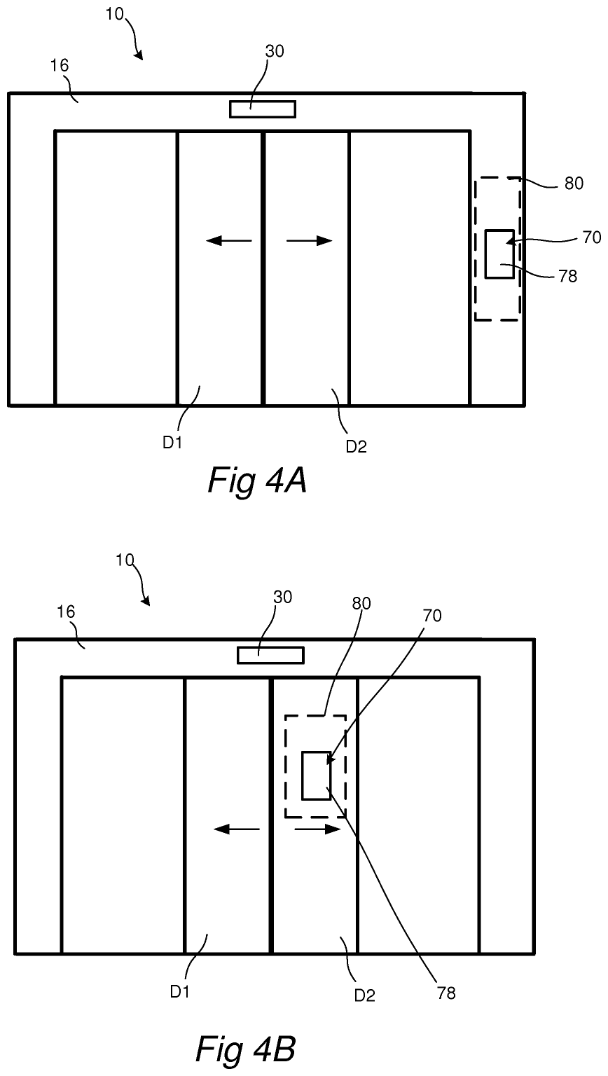

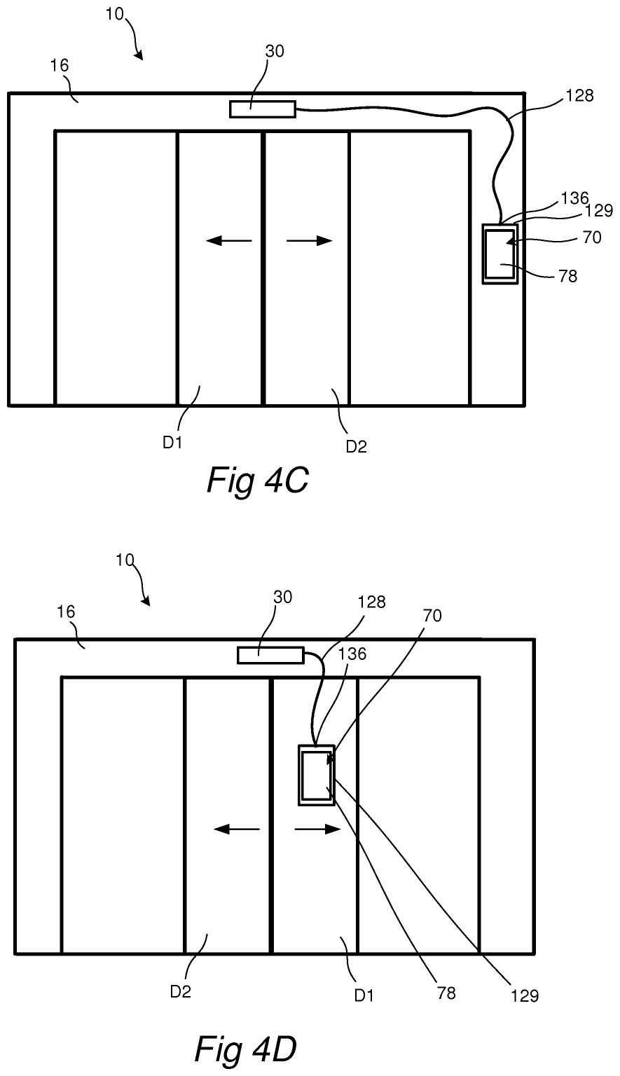

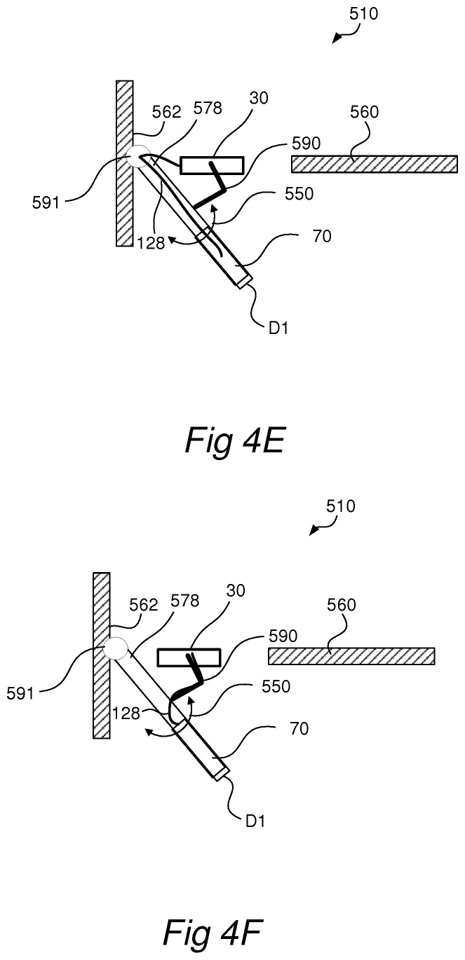

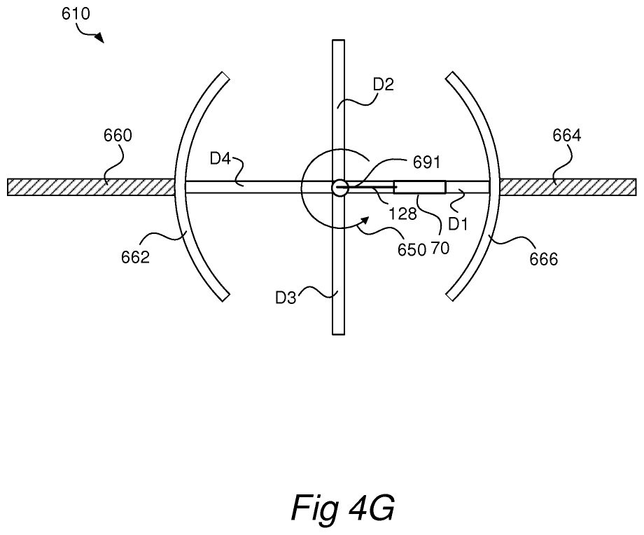

The automatic door operator 30 may typically be arranged in conjunction with a support structure 16 (as seen in FIGS. 4a-b), such as a frame or other structure which supports the door members D1 . . . Dm for movements between closed and open positions, often as a concealed overhead installation in or at the frame or support structure. In one embodiment, the support structure 16 comprise one or more glass window(s) 80 arranged somewhere in the support structure 16. In an alternative embodiment, the support structure 16 is completely constructed by glass windows 80. In yet an alternative embodiment the support structure does not comprise any glass windows 80.

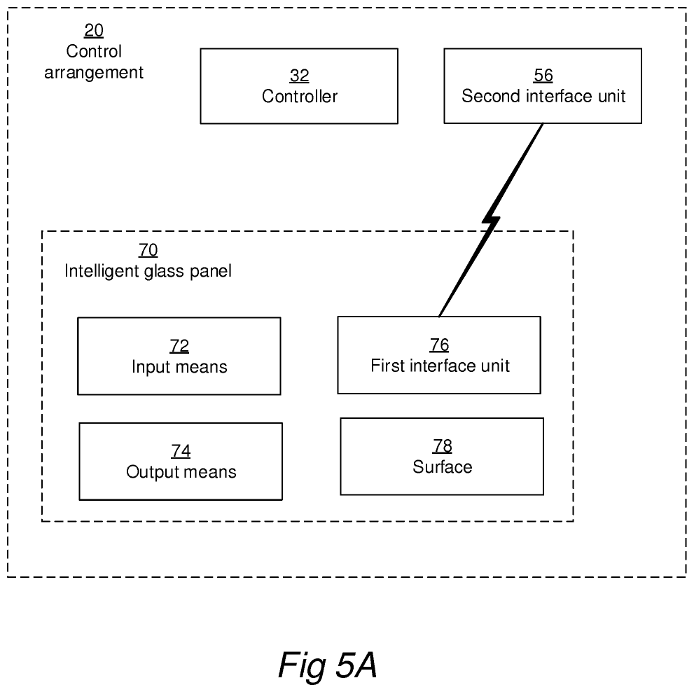

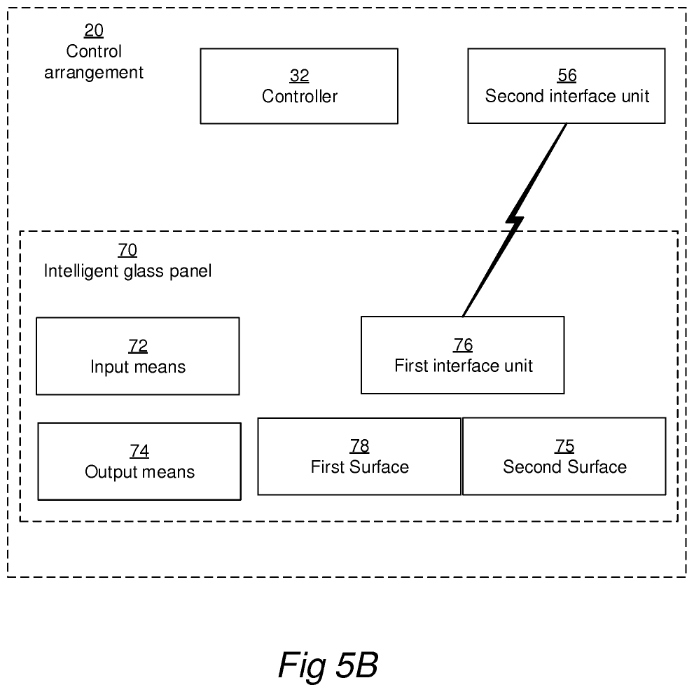

Pursuant to the disclosed embodiment, the control arrangement 20 further comprises an intelligent glass panel 70 and a second interface unit 56. The intelligent glass panel 70 is integrated with any of the movable door members D1 . . . Dm or the support structure 16 and is operatively connected with the controller 32. The intelligent glass panel 70 is configured to act as a user interface to the entrance system for a human user. The intelligent glass panel 70 and the second interface unit 56 will be described more in detail with reference to FIGS. 4a-b and FIG. 5.

The embodiment of the automatic door operator 30 shown in FIG. 2 will now be described in more detail. In addition to the aforementioned controller 32, the automatic door operator 30 comprises a motor 34, typically an electrical motor, being connected to an internal transmission or gearbox 35. An output shaft of the transmission 35 rotates upon activation of the motor 34 and is connected to the external transmission mechanism 40. The external transmission mechanism translates the motion of the output shaft of the transmission 35 into an opening or a closing motion of one or more of the door members D1 . . . Dm with respect to the frame or support structure.

The controller 32 is configured for performing different functions of the automatic door operator 30 in the different operational states of the entrance system 10, using inter alia sensor input data from the plurality of sensors S1 . . . Sn. Hence, the outputs of the plurality of sensors S1 . . . Sn are connected to data inputs of the controller 32. At least some of the different functions performable by the controller 32 have the purpose of causing desired movements of the door members D1 . . . Dm. To this end, the controller 32 has at least one control output connected to the motor 34 for controlling the actuation thereof.

The controller 32 may be implemented in any known controller technology, including but not limited to microcontroller, processor (e.g. PLC, CPU, DSP), FPGA, ASIC or any other suitable digital and/or analog circuitry capable of performing the intended functionality.

The controller 32 also has an associated memory 33. The memory 33 may be implemented in any known memory technology, including but not limited to E(E)PROM, S(D)RAM or flash memory. In some embodiments, the memory 33 may be integrated with or internal to the controller 32. The memory 33 may store program instruction for execution by the controller 32, as well as temporary and permanent data used by the controller 32.

Turning now to FIG. 3A, a first embodiment of an entrance system in the form of a sliding door system 410 is shown in a schematic top view. The sliding door system 410 comprises first and second sliding doors or wings D1 and D2, being supported for sliding movements 4501 and 4502 in parallel with first and second wall portions 460 and 464. The first and second wall portions 460 and 464 are spaced apart; in between them there is formed an opening which the sliding doors D1 and D2 either blocks (when the sliding doors are in closed positions), or makes accessible for passage (when the sliding doors are in open positions). An automatic door operator (not seen in FIG. 3A but referred to as 30 in FIGS. 1 and 2) causes the movements 4501 and 4502 of the sliding doors D1 and D2.

The sliding door system 410 comprises a plurality of sensors, each monitoring a respective zone Z1-Z6. The sensors themselves are not shown in FIG. 3A, but they are generally mounted at or near ceiling level and/or at positions which allow them to monitor their respective zones Z1-Z6. To facilitate the reading, each sensor will be referred to as Sx in the following, where x is the same number as in the zone Zx it monitors (Sx=S1-S6, Zx=Z1-Z6).

A first sensor S1 is mounted at a lateral position to the far left in FIG. 3A to monitor zone Z1. The first sensor S1 is a side presence sensor, and the purpose is to detect when a person or object occupies a space between the outer lateral edge of the sliding door D1 and an inner surface of a wall or other structure 462 when the sliding door D1 is moved towards the left in FIG. 3A during an opening state of the sliding door system 410. The provision of the side presence sensor S1 will help avoiding a risk that the person or object will be hit by the outer lateral edge of the sliding door D1, and/or jammed between the outer lateral edge of the sliding door D1 and the inner surface of the wall 462, by triggering abort and preferably reversal of the ongoing opening movement of the sliding door D1.

A second sensor S2 is mounted at a lateral position to the far right in FIG. 3A to monitor zone Z2. The second sensor S2 is a side presence sensor, just like the first sensor S1, and has the corresponding purpose i.e. to detect when a person or object occupies a space between the outer lateral edge of the sliding door D2 and an inner surface of a wall 466 when the sliding door D2 is moved towards the right in FIG. 3A during the opening state of the sliding door system 410.

A third sensor S3 is mounted at a first central position in FIG. 3A to monitor zone Z3. The third sensor S3 is a door presence sensor, and the purpose is to detect when a person or object occupies a space between or near the inner lateral edges of the sliding doors D1 and D2 when the sliding doors D1 are moved towards each other in FIG. 3A during a closing state of the sliding door system 410. The provision of the door presence sensor S3 will help avoiding a risk that the person or object will be hit by the inner lateral edge of the sliding door D1 or D2, and/or be jammed between the inner lateral edges of the sliding doors D1 and D2, by aborting and preferably reversing the ongoing closing movements of the sliding doors D1 and D2.

A fourth sensor S4 is mounted at a second central position in FIG. 3A to monitor zone Z4. The fourth sensor S4 is a door presence sensor, just like the third sensor S3, and has the corresponding purpose i.e. to detect when a person or object occupies a space between or near the inner lateral edges of the sliding doors D1 and D2 when the sliding doors D1 are moved towards each other in FIG. 3A during a closing state of the sliding door system 410.

The side presence sensors S1 and S2 and door presence sensors S3 and S4 may for instance be active IR (infrared) sensors.

A fifth sensor S5 is mounted at an inner central position in FIG. 3A to monitor zone Z5. The fifth sensor S5 is an inner activity sensor, and the purpose is to detect when a person or object approaches the sliding door system 410 from the inside of the premises. The provision of the inner activity sensor S5 will trigger the sliding door system 410, when being in a closed state or a closing state, to automatically switch to an opening state for opening the sliding doors D1 and D2, and then make another switch to an open state when the sliding doors D1 and D2 have reached their fully open positions.

A sixth sensor S6 is mounted at an outer central position in FIG. 3A to monitor zone Z6. The sixth sensor S6 is an outer activity sensor, and the purpose is to detect when a person or object approaches the sliding door system 410 from the outside of the premises. Similar to the inner activity sensor S5, the provision of the outer activity sensor S6 will trigger the sliding door system 410, when being in its closed state or its closing state, to automatically switch to the opening state for opening the sliding doors D1 and D2, and then make another switch to an open state when the sliding doors D1 and D2 have reached their fully open positions.

The inner activity sensor S5 and the outer activity sensor S6 may for instance be radar (microwave) sensors.

A second embodiment of an entrance system in the form of a swing door system 510 is shown in a schematic top view in FIG. 3B. The swing door system 510 comprises a single swing door D1 being located between a lateral edge of a first wall 560 and an inner surface of a second wall 562 which is perpendicular to the first wall 560. The swing door D1 is supported for pivotal movement 550 around pivot points on or near the inner surface of the second wall 562. The first and second walls 560 and 562 are spaced apart; in between them an opening is formed which the swing door D1 either blocks (when the swing door is in closed position), or makes accessible for passage (when the swing door is in open position). An automatic door operator (not seen in FIG. 3B but referred to as 30 in FIGS. 1 and 2) causes the movement 550 of the swing door D1.

The swing door system 510 comprises a plurality of sensors, each monitoring a respective zone Z1-Z4. The sensors themselves are not shown in FIG. 3B, but they are generally mounted at or near ceiling level and/or at positions which allow them to monitor their respective zones Z1-Z4. Again, each sensor will be referred to as Sx in the following, where x is the same number as in the zone Zx it monitors (Sx=S1-S4, Zx=Z1-Z4).

A first sensor S1 is mounted at a first central position in FIG. 3B to monitor zone Z1. The first sensor S1 is a door presence sensor, and the purpose is to detect when a person or object occupies a space near a first side of the (door leaf of the) swing door D1 when the swing door D1 is being moved towards the open position during an opening state of the swing door system 510. The provision of the door presence sensor S1 will help avoiding a risk that the person or object will be hit by the first side of the swing door D1 and/or be jammed between the first side of the swing door D1 and the second wall 562; a sensor detection in this situation will trigger abort and preferably reversal of the ongoing opening movement of the swing door D1.

A second sensor S2 is mounted at a second central position in FIG. 3B to monitor zone Z2. The second sensor S2 is a door presence sensor, just like the first sensor S1, and has the corresponding purpose i.e. to detect when a person or object occupies a space near a second side of the swing door D1 (the opposite side of the door leaf of the swing door D1) when the swing door D1 is being moved towards the closed position during a closing state of the swing door system 510. Hence, the provision of the door presence sensor S2 will help avoiding a risk that the person or object will be hit by the second side of the swing door D1 and/or be jammed between the second side of the swing door D1 and the first wall 560; a sensor detection in this situation will trigger abort and preferably reversal of the ongoing closing movement of the swing door D1.

The door presence sensors S1 and S2 may for instance be active IR (infrared) sensors.

A third sensor S3 is mounted at an inner central position in FIG. 3B to monitor zone Z3. The third sensor S3 is an inner activity sensor, and the purpose is to detect when a person or object approaches the swing door system 510 from the inside of the premises. The provision of the inner activity sensor S3 will trigger the sliding door system 510, when being in a closed state or a closing state, to automatically switch to an opening state for opening the swing door D1, and then make another switch to an open state when the swing door D1 has reached its fully open position.

A fourth sensor S4 is mounted at an outer central position in FIG. 3B to monitor zone Z4. The fourth sensor S4 is an outer activity sensor, and the purpose is to detect when a person or object approaches the swing door system 510 from the outside of the premises. Similar to the inner activity sensor S3, the provision of the outer activity sensor S4 will trigger the swing door system 510, when being in its closed state or its closing state, to automatically switch to the opening state for opening the swing door D1, and then make another switch to an open state when the swing door D1 has reached its fully open position.

The inner activity sensor S3 and the outer activity sensor S4 may for instance be radar (microwave) sensors.

A third embodiment of an entrance system in the form of a revolving door system 610 is shown in a schematic top view in FIG. 3C. The revolving door system 610 comprises a plurality of revolving doors or wings D1-D4 being located in a cross configuration in an essentially cylindrical space between first and second curved wall portions 662 and 666 which, in turn, are spaced apart and located between third and fourth wall portions 660 and 664. The revolving doors D1-D4 are supported for rotational movement 650 in the cylindrical space between the first and second curved wall portions 662 and 666. During the rotation of the revolving doors D1-D4, they will alternatingly prevent and allow passage through the cylindrical space. An automatic door operator (not seen in FIG. 3C but referred to as 30 in FIGS. 1 and 2) causes the rotational movement 650 of the revolving doors D1-D4.

The revolving door system 610 comprises a plurality of sensors, each monitoring a respective zone Z1-Z8. The sensors themselves are not shown in FIG. 3C, but they are generally mounted at or near ceiling level and/or at positions which allow them to monitor their respective zones Z1-Z8. Again, each sensor will be referred to as Sx in the following, where x is the same number as in the zone Zx it monitors (Sx=S1-S8, Zx=Z1-Z8).

First to fourth sensors S1-S4 are mounted at respective first to fourth central positions in FIG. 3C to monitor zones Z1-Z4. The first to fourth sensors S1-S4 are door presence sensors, and the purpose is to detect when a person or object occupies a respective space (sub-zone of Z1-Z4) near one side of the (door leaf of the) respective revolving door D1-D4 as it is being rotationally moved during a rotation state or start rotation state of the revolving door system 610. The provision of the door presence sensors S1-S4 will help avoiding a risk that the person or object will be hit by the approaching side of the respective revolving door D1-D4 and/or be jammed between the approaching side of the respective revolving door D1-D4 and end portions of the first or second curved wall portions 662 and 666. When any of the door presence sensors S1-S4 detects such a situation, it will trigger abort and possibly reversal of the ongoing rotational movement 650 of the revolving doors D1-D4.

The door presence sensors S1-S4 may for instance be active IR (infrared) sensors.

A fifth sensor S5 is mounted at an inner non-central position in FIG. 3C to monitor zone Z5. The fifth sensor S5 is an inner activity sensor, and the purpose is to detect when a person or object approaches the revolving door system 610 from the inside of the premises. The provision of the inner activity sensor S5 will trigger the revolving door system 610, when being in a no rotation state or an end rotation state, to automatically switch to a start rotation state to begin rotating the revolving doors D1-D4, and then make another switch to a rotation state when the revolving doors D1-D4 have reached full rotational speed.

A sixth sensor S6 is mounted at an outer non-central position in FIG. 3C to monitor zone Z6. The sixth sensor S6 is an outer activity sensor, and the purpose is to detect when a person or object approaches the revolving door system 610 from the outside of the premises. Similar to the inner activity sensor S5, the provision of the outer activity sensor S6 will trigger the revolving door system 610, when being in its no rotation state or end rotation state, to automatically switch to the start rotation state to begin rotating the revolving doors D1-D4, and then make another switch to the rotation state when the revolving doors D1-D4 have reached full rotational speed.

The inner activity sensor S5 and the outer activity sensor S6 may for instance be radar (microwave) sensors.

Seventh and eighth sensors S7 and S8 are mounted near the ends of the first or second curved wall portions 662 and 666 to monitor zones Z7 and Z8. The seventh and eighth sensors S7 and S8 are vertical presence sensors. The provision of these sensors S7 and S8 will help avoiding a risk that the person or object will be jammed between the approaching side of the respective revolving door D1-D4 and an end portion of the first or second curved wall portions 662 and 666 during the start rotation state and the rotation state of the revolving door system 610. When any of the vertical presence sensors S7-S8 detects such a situation, it will trigger abort and possibly reversal of the ongoing rotational movement 650 of the revolving doors D1-D4.

The vertical presence sensors S7-S8 may for instance be active IR (infrared) sensors.

In prior art systems, an operator panel is provided at the entrance system, typically in the form of a box which is installed next to the movable door members. A user may set the current operating mode by pressing a button on the operator panel. An operator panel box requires space, cabling and installation work, in addition to the fact that the box itself obviously has a cost. In some public areas, it may be difficult to install an operator panel box properly because of space constraints or the surface materials of the public area in question. Also, due to its location in a public area, the operator panel box will be exposed not only to environmental wear and tear, but also to a risk of vandalism, manipulation or usage by unauthorized people.

According to the inventive concept, as will be described more in detail with reference to FIGS. 4-7, the intelligent glass panel 70, being integrated with any of the movable door members D1 . . . Dm or the support structure 16, is configured to act as a user interface to the entrance system 10 for a human user. Since the operator panel is integrated in the door members D1 . . . Dm or in the support structure 16 it requires less space and is less prone for being exposed to environmental wear and tear. Additionally, the risk of vandalism, manipulation or usage by unauthorized people is reduced. Furthermore, thanks to it flat surface without any protruding elements the glass panel can be easily kept clean and will have an aesthetic appearance. Hence, the intelligent glass panel thus eliminates or at least migrates the problems described above.

FIGS. 4a-b illustrates different embodiments of an entrance system having a control arrangement 20 with an intelligent glass panel 70. The glass panel 70 may be seen as an operator panel, a mode selector or any other device configured to act as a user interface to the entrance system 10 for a human user.

In both embodiments, the entrance system 10 comprises two movable door members D1, D2 and a support structure 16 for supporting the two movable door members D1, D2 between the closed and opened positions.

In the embodiment shown in FIG. 4a, the intelligent glass panel 70 is integrated with the support structure 16. Preferably, the intelligent glass panel 70 is integrated with a glass window 80 arranged in the support structure 16. As previously described, the support structure 16 may be completely or partly constructed by glass windows 80. In certain embodiments, the intelligent glass panel 70 may encompass the entire support structure, or alternatively only a portion of the support structure.

Having the intelligent glass panel 70 integrated in the support structure 16 is especially beneficial in the situations where the support structure 60 is constructed mainly or in full by a glass section or a plurality of glass sections. Arranging a prior art operator panel on such a glass support structure 60 would be quite difficult and unappealing due to the wire routing and fixation.

In the embodiment shown in FIG. 4b, the intelligent glass panel 70 is integrated with one of the movable door members D1, D2 or more specifically the second movable door member D2 in the example seen in FIG. 4B. Preferably, the intelligent glass panel 70 is integrated with a glass window 80 arranged in one of the movable door members D1, D2. One or both of the movable door members D1, D2 may comprise one or a plurality of glass windows 80. The glass window 80 may cover the whole door member D1, D2 or just a portion of one of the door members D1, D2. In certain embodiments, the intelligent glass panel 70 may encompass the entire movable door member, or only a portion of the movable door member.

Having the intelligent glass panel 70 integrated in one of the movable door members D1, D2 is especially beneficial in space constrained areas. The area may for example not have room for a wide support structure 16, hence the intelligent glass panel 70 may not be able to fit with the support structure 16.

In both the embodiments shown in FIGS. 4a-b, the glass panel 70 and the glass window 80 may be constructed as a single unit, or as separate units being fixedly assembled during the manufacturing process. In some embodiments the glass window 80 is the surface of the intelligent glass panel 70, i.e. the user may press a virtual button on the surface of the glass window. The intelligent glass panel 70 is preferably transparent, i.e. allowing the user to see through it, this allows for a more aesthetic entrance system 10 since the glass window 80 and the intelligent glass panel 70 will look the same or at least very similar in appearance.

Referring to FIG. 4C-G, embodiments of the entrance system are schematically depicted. The entrance system may for example be in the form of a revolving door system, sliding door system and swing door system.

In one embodiment the intelligent glass panel 70 is integrated with any of the movable door members D1 . . . Dm or the support structure 16 via a frame 129. The frame 129 is mounted to the movable door members D1 . . . Dm or the support structure 16. The frame 129 is arranged to receive the intelligent glass panel 70.

In one embodiment the frame 129 may be disposed adjacent to an edge of the movable door member D1 . . . Dm or the support structure 16, respectively so as to hide the wiring 129.

The frame enables the intelligent glass panel to extend through the whole door member or support structure while maintain the desirable sealing properties of the entrance system. Further said frame may enable a simpler mounting of the intelligent glass panel.

In one embodiment the frame 129 is in an elastic material such as rubber. The frame 129 may be a rubber sealing arranged to surround the intelligent glass panel 70, preferably in a sealing manner.

In one embodiment the intelligent glass panel 70 may be operatively connected to the controller by means of wiring 128. The wiring 128 may be in the form of any conventional and suitable wiring known in the arts. The wiring 128 may be configured to power and/or transfer input/output data to and from the intelligent glass panel 70. Compared to wireless power transferring means the wiring allows for a more stable power transfer. This may be particularly advantageous when powering GUIs since any potential interference in the power transfer may cause flickering in the display and resulting discomfort for the human user accessing the GUI.

In one embodiment the controller 30 is integrated with the automatic door operator 30, whereby the wiring 128 is routed to said automatic door operator 30.

Referring to FIG. 4C in one embodiment the intelligent glass panel 70 may be integrated with the support structure 16, whereby the wiring 128 may be routed through said support structure 16. In one embodiment the wiring 128 may be routed through said support structure 16 so as to be at least partially integrated into said support structure 16. For example the wiring may be at least partially integrated by means of being disposed behind a cover panel of the movable door member or being positioned inside a wiring channel provided in the movable door member arranged to receive said wiring 128.

The entrance system may be the depicted sliding door system or any other conventional entrance system.

Referring to FIG. 4D in one embodiment the intelligent glass panel 70 may be integrated with the movable door member D1, whereby the wiring 128 may be routed through said movable door member D1. In one embodiment the wiring 128 may be routed through said movable door member D1 so as to be at least partially integrated into said movable door member. For example the wiring may be at least partially integrated by means of being disposed behind a cover panel of the support structure 16 or being positioned inside a wiring channel provided in the support structure 16 arranged to receive said wiring 128.

The entrance system may be the depicted sliding door system or any other conventional entrance system. In one embodiment both of the movable door members D1 and D2 or only the movable door member D2 may have intelligent glass panels integrated therein, both of which being operatively connected to the controller integrated with the automatic door operator 30.

In one embodiment the frame 129 may comprise at least one aperture 136 for receiving the wiring 128. The wiring 128 may be consequently be routed through the frame 129 by means of said at least one aperture 136.

Hence the wiring may be hidden whereby a more visually aesthetic door entrance system is achieved. Also the wiring may be less susceptible to wear and vandalism due to it being less exposed.

Referring to FIG. 4E and FIG. 4F the entrance system may be in the form of the swing door system 510 wherein the intelligent glass panel 70 is integrated with the movable door member D1.

In one embodiment schematically depicted in FIG. 4E, the movable door member D1 is pivotally supported by means of a hinge arrangement 591. The hinge arrangement 590 is adapted to pivotally support the movable door member D1. The wiring 128 may be routed to the automatic door operator 30 via said hinge arrangement 591. Thus the pieces of wiring exposed is reduced which in turn reduces the risk of sabotage and/or wear.

The hinge arrangement 590 may be in the form of a hollow axle whereby the hollow axle is arranged to receive the wiring 128.

In one embodiment schematically depicted in FIG. 4F, the wiring 128 may be routed to the automatic door operator 30 via an arm linkage 590. The arm linkage 590 connects the automatic door operator 30 and the movable door member D1. The arm linkage 590 is arranged to transfer torque from the automatic door operator 30 to the movable door member D1. The wiring 128 may be routed via the arm linkage 590 by being wound around the arm linkage 590 or by means of the arm linkage 590 being provided with fastening means in the form of a passage or fastening elements for holding the wiring 128 in place. The above described routing of wiring via the arm linkage may effectively reduce the pieces of wiring accessible for sabotage.

In one embodiment schematically depicted in FIG. 4G, the entrance system may be in the form of a revolving door system 610. The intelligent glass panel 70 may be integrated with the movable door member D1.

The wiring 128 may be routed to the automatic door operator 30 via a centrum shaft 691, i.e. a vertical centrum shaft. The centrum shaft 691 is for supporting the rotational movement of the movable door members D1 . . . Dm. Thus, the revolving door system 610 may comprise said centrum shaft 691 arranged to receive torque from the automatic door operator 30, whereby the movable door members D1 . . . Dm are fixed to said centrum shaft so as to allow for the movement of the movable door members D1 . . . Dm. Thus, the pieces of the wiring being exposed may be reduced, resulting in reduced wear and a lower risk for sabotage.

In one embodiment the wiring may be routed 128 towards the centrum shaft 691 via the movable door member D1. The wiring 128 may be routed via the movable door member by means of said wiring 128 being integrated into the movable door member or by means of being attached to said movable door member.

In one embodiment the wiring may be routed towards the centrum shaft 691 via the movable door member D1 and the support structure 16. The wiring 128 may be routed via the movable door member D1 and the support structure by means of being integrated into the movable door member D1 and/or support structure 16 and/or by means of being attached to said movable door member D1 and/or support structure 16.

In one embodiment the automatic door operator 30 may be disposed inside the centrum shaft 691.

FIG. 5A is a schematic illustration of some parts of the control arrangement 20. As briefly mentioned in relation to FIG. 1, the control arrangement 20 comprises a second interface unit 56. The second interface unit 56 may comprise a network interface that complies with one or more short-range wireless data communication standards such as Bluetooth®, WiFi (e.g. IEEE 802.11, wireless LAN), Near Field Communication (NFC), RF-ID (Radio Frequency Identification) or Infrared Data Association (IrDA). Alternatively or additionally, the second interface unit 56 may comprise a network interface for connecting to one or more communications network(s). The network interface may comply with any commercially available mobile telecommunications standard, including but not limited to GSM, UMTS, LTE, D-AMPS, CDMA2000, FOMA and TD-SCDMA. Alternatively or additionally, the network interface may comply with any commercially available standard for data communication, such as for instance TCP/IP.

Intelligent Glass Panel

The control arrangement 20 further comprises an intelligent glass panel 70. The glass panel comprises a surface 78 for receiving touch actuations, input means 72 configured for detecting touch actuation on the surface 78, output means 74 for causing presentation of output data and a first interface unit 76 for communicating with the second interface unit 56 of the control arrangement 20. The different parts will now be described more in detail.

In one embodiment the intelligent glass panel 70 comprises a touch-sensitive display that acts both as input means 72 and output means 74. The touch-sensitive display comprises the surface 78 which is the physical component that the user will directly interact with using virtual gestures.

In one embodiment the touch-sensitive display comprises a thin transparent layer of plastic as known in the art. The touch-sensitive display may be a capacitive display. Preferably, the touch-sensitive display is a transparent display. By having a transparent display the light may pass through the display such that actual objects behind the intelligent glass panel 70 may be seen through the display. In one embodiment, both real-world objects and graphical images rendered by the intelligent glass panel 70 may be visible on the display simultaneously. In order to selectively render the intelligent glass panel transparent, the display may for example comprise a liquid crystal substance disposed between two substrates (as in the case of an LCD) or organic layers that operate to emit light (as in the case of an OLED display).

The intelligent glass panel 70 according to one embodiment is schematically depicted in FIG. 5B. As previously described the touch-sensitive screen is adapted to act both as input mean and output mean. The transparency of the touch-sensitive screen allows for the information presented on the screen being visible from both sides of the intelligent glass panel 70.

In one embodiment the input means 72 is configured for detecting touch actuation on a second surface 75 of the intelligent glass panel 70 by the human user and in response producing input data. The surface 78 is accessible for a human user from a first side of the intelligent glass panel 70 and the second surface 75 is accessible for a human user from a second side of the intelligent glass panel 70. The first side is opposite to the second side.

The intelligent glass panel 70 is arranged so as to allow access to the human user interface from both sides. This is achieved by the intelligent glass panel 70 being integrated into with any of the movable door members D1 . . . Dm or the support structure 16 such that the surface 78 is accessible for a human user from a first side of said movable door member D1 . . . Dm or said support structure 16. The second surface is accessible for a human user from a second side of said movable door member D1 . . . Dm or said support structure 16. The first side is opposite to the second side.

Similar to the (first) surface 78, the second surface 75 is the physical component that the human user will directly interact with using virtual gestures. The intelligent glass panel 70 comprises the (first) surface 78 and the second surface 75 on each side of the touch-sensitive display.

In one embodiment the touch-sensitive screen comprises the first surface 78 and the second surface 75, said first and second surface comprising capacitive film for receiving touch actuation.

Thereby, the same transparent display may be configured to act as a user interface of the entrance system 10 from both sides of the intelligent glass panel. A single touch-screen transparent may be utilized instead of two separate user interfaces on each side.

Further, the previously described advantages with the transparent user interface may be achieved while allowing for control from both sides of the entrance system to a lower cost. Also, said advantages is achieved while requiring less space in the entrance system.

In one embodiment the input means 72 is configured for detecting which of the first or second surface 78, 75 has been touch actuated and the output means 74 is configured for altering the presentation of output data in response to which of the first or second surface 78, 75 has been touch actuated. Thus the presented data may be altered depending on different conditions being present for example on each side of the movable door member or support structure. For example, the lighting may differ, whereby there may be a need to alter the presented data by means of color or lighting depending on which side the human user accessing the interface is standing. According to another example the first side may be associated with a first access level while the second side may be associated with a second access level. Thus it may be advantageous to present data in a manner which is suitable for the access level in question.

In one embodiment, the output means 74 is configured for causing altering the presentation of data by means of mirroring said data. In other words, the graphical representation of the data to be presented is mirrored. If the presented data is viewed from both sides of intelligent glass panel 70, the presented data will be perceived differently based on which side the user is standing. Thus, by mirroring the presentation of output data the presented data will always be intelligible for the user accessing the interface.

In one embodiment the entrance system may be in the form a revolving door system 610, whereby the support structure may comprise a curved support section in the form of a curved wall portion 662 or 666 and the intelligent glass panel 70 may have a curved shape. The touch-screen display may thus have a curved shape so as to substantially follow the curved shape, i.e. the curvature, of the curved wall portion 662 or 666. The touch-screen display may be a curved LCD or LED screen.

Input Data

The intelligent glass panel 70 may display virtual buttons in a graphical user interface for allowing the user to produce input data. The input means 72 is configured for detecting a touch actuation on the surface 78 of the intelligent glass panel. In response to the touch actuation on the surface 78, the input means 72 produces input data. The input data is transmitted to the controller 32 of the control arrangement 20 where it is processed. The input data may represent different situations as will now be described.

In one embodiment the input data represents a choice of a selected operating mode in which the automatic door operator 30 shall operate. Preferably, the user may select one desired operating mode among a plurality of operating modes. In some embodiments the entrance system described with reference to FIGS. 1 to 4, has a plurality of different operating modes in which the automatic door operator 30 may be operated.

One operating mode may be a first automatic operating mode in which the controller 32 controls the automatic door operator 30 to cause movements of the one or more movable door members D1 . . . Dm based on sensor input data from the plurality of sensors S1 . . . Sn, allowing bidirectional passage through the entrance system 10. Hence, people are allowed both to walk into and/or exit an area through the entrance system 10. The passage will in the following be referred to a passage of people. However as would be readily understood by a person skilled in the art, the entrance system described herein may also be used for passage of animals, vehicles, robots or the like.

Another operating mode may be a second automatic operating mode in which the controller 32 controls the automatic door operator 30 to cause movements of the one or more movable door members D1 . . . Dm based on sensor input data from the plurality of sensors S1 . . . Sn, allowing unidirectional passage through the entrance system 10. This mode may be also be referred to as Exit (Automatic Exit Only), in which the entrance system 10 is operated in a situation in which all people shall leave the premises where the entrance system is installed, for instance when a shopping mall closes for the day, or when an escape situation has occurred.

An additional operation mode may be a first forced-position operating mode in which the controller 32 controls the automatic door operator 30 to cause the one or more movable door members D1 . . . Dm to remain in steady open positions, allowing bidirectional passage through the entrance system 10. This mode may also be referred to as Open, in which all the movable door members D1 . . . Dm take steady open positions not involving movements of the door members D1 . . . Dm by the automatic door operator. This mode may for example be beneficial during the summer in hot weather conditions where it may be desirable to ventilate.

A further operating mode may be a second forced-position operating mode in which the controller 32 controls the automatic door operator 30 to cause the one or more movable door members D1 . . . Dm to remain in steady closed positions, prohibiting passage through the entrance system. This mode, also referred to as Lock Door, may for example be used when no people are allowed into the premises where the entrance system is installed, for instance when a shopping mall is closed for the day.

Yet another operating mode may be a manual operating mode in which the controller 32 controls the automatic door operator 30 to allow manual movement of the one or more movable door members D1 . . . Dm.

As is readily understood by those skilled in the art, other operating modes than those described herein could be used by the entrance system 10 and selected by using the input means 72 of the intelligent glass panel 70.

Additionally or alternatively, the input means 72 of the intelligent glass panel 70 is configured for producing input data representing a setting of an operational parameter of the automatic door operator 30.

Additionally or alternatively, the input means 72 of the intelligent glass panel 70 is configured for producing input data representing a reset of an alarm triggered or detected by the automatic door operator 30. An alarm may for example be triggered due to malfunctioning of any part of the entrance system 10 or by an indication of a forced entry into the intelligent glass panel 70, the automatic door operator 30 and/or one of the movable door members D1 . . . Dm.

It may be beneficial to restrict the access to the entrance system 10 so that only certain users, such as authorized personnel, may be able to input data into the input means 72 of the intelligent glass panel 70. If the entrance system 10 is arranged in a store, it may for example be beneficial that all the store personnel have access to change the operating mode while the customers visiting the shop are denied such access. Hence, additionally or alternatively, the input means 72 of the intelligent glass panel 70 may be configured for producing input data representing a passcode. A passcode may for example be required for the user to be able to execute any task at all or in order to perform certain tasks. For example, a passcode may be required to be able to select an operating mode, to adjust the setting of an operational parameter and/or to reset an alarm triggered or detected by the automatic door operator 30. The passcode may for example be a sequence of numbers, letters and/or symbols. In one embodiment, the passcode may also consist of fingerprint recognition.

In some embodiments an external computing resource is configured to require verification of user credentials of the user of the intelligent glass panel 70 in order to communicate an instruction for setting the selected operating mode of the automatic door operator 30. The verification of the user credentials may be done automatically or manually by the user. The user may for example log into a specific account in a server-side application on the external computing resource. The allowed user credentials may be saved in the external computing resource and/or in an associated database. Alternatively, verification may be done by a trusted third-party service provided on the Internet. The user may receive feedback on a successful or unsuccessful verification of the user credentials.

The above stated input data shall merely be seen as examples, and other input data could be generated using the input means 72 of the intelligent glass panel 70.

Output Data

Before the user makes a touch actuation in order to generate input data, the intelligent glass panel 70 preferably shows some information in the graphical user interface, for example a list illustrating the possible input data that could be generated. Furthermore, once the user has made a touch actuation on the surface 78 of the intelligent glass panel 70 so that input data is generated, it is preferred that the user would receive feedback on his/her action. Hence, the output means 74 of the intelligent glass panel 70 is configured for causing presentation of output data in the intelligent glass panel 70. The output data is presented in order to provide information and/or feedback to the user.

As previously described, the output means 74 preferably comprises a display for displaying information. More preferably, the input means 72 and the output means 74 are the same touch-sensitive display in the disclosed embodiment. Hence, the touch-sensitive surface 78 acts both as input means 72 and as output means 74.

The output data could relate to different information and situations, as will now be described. In one embodiment the output data represents an operational data of the entrance system 10. The operational data may pertain to an operational status of the automatic door operator 30 and/or operational statistics of the entrance system 10.

The operational data of the automatic door operator 30 could for example comprise information relating to which operating mode that is chosen, operating modes that are available to be chosen and/or operating modes that could not be chosen. The operational status could also show specific information of the status of each sensor, etc.

Operational statistics of the entrance system 10 may for example pertain to usage statistics about the entrance system 10 such as the number of openings of the door members D1 . . . Dm, the number of changes of operating mode, passage count, number of passages at certain time periods, etc. The use may user the intelligent glass panel 70 in order to reset the counter and/or to set up additional statistical information of interest.

Additionally or alternatively, the output data may represent an indication of an event. The event may for example be a need for maintenance of repair and/or an indication of an alarm triggered or detected by the automatic door operator 30.

The indication of a need for maintenance may for example comprise information on what or which part(s) that need(s) to be repaired or maintained, and/or contact details for suitable maintenance personnel. Once the service technician is in the vicinity of the entrance system 10, he/she may log into a service account, using a passcode, in order to receive additional information about the status of the entrance system 10. The service technician may also be able to input new settings and/or to update the available modes and parameters.

The output data may also present information that assists the user for inputting input data. This may for example be an illustration on how to generate a specific piece of input data, for example by showing a cartoon sequence. The information may also be in the form of a text that explains the benefits with the different operational modes or parameters. If a passcode is required, the information may serve to help the user to remember his/her passcode by for example asking personal questions.

First Interface Unit

The first interface unit 76 may comprise a network interface that complies with one or more short-range wireless data communication standards such as Bluetooth®, WiFi (e.g. IEEE 802.11, wireless LAN), Near Field Communication (NFC), RF-ID (Radio Frequency Identification) or Infrared Data Association (IrDA). Alternatively or additionally, the first interface unit 76 may comprise a network interface for connecting to one or more communications network(s). The network interface may comply with any commercially available mobile telecommunications standard, including but not limited to GSM, UMTS, LTE, D-AMPS, CDMA2000, FOMA and TD-SCDMA. Alternatively or additionally, the network interface may comply with any commercially available standard for data communication, such as for instance TCP/IP.

The first interface unit 76 is adapted to communicate with the second interface unit 56, which in turn is coupled to the controller 32. The first interface unit 76 transmits the input data produced by the input means 72 of the intelligent glass panel 70 to the second interface unit 56. The second interface unit 56 is thus configured to receive, from the first interface unit 76, the input data produced by the input means 72 of the intelligent glass panel 70 and to transfer the input data to the controller 32. The second interface unit 56 is further configured to receive, from the controller 32, the output data to be presented by the output means 74 of the intelligent glass panel 70, and to transfer the output data to the first interface unit 76 of the intelligent glass panel 70.

Hence, the first interface unit 76 is configured for communicating the input data produced by the input means 72 to the controller 32 and configured for receiving, from the controller 32, the output data to be presented by the output means 74.

Additionally or alternatively, the output data may show a confirmation that the input data has been successfully generated. The confirmation may for example relate to a selected operating mode in which the automatic door operator 30 shall operate, a setting of an operational parameter of the automatic door operator 30, and/or a reset of an alarm triggered or detected by the automatic door operator 30. The confirmation reassures the user that he/she has been successful in generating input data on the intelligent glass panel 70.

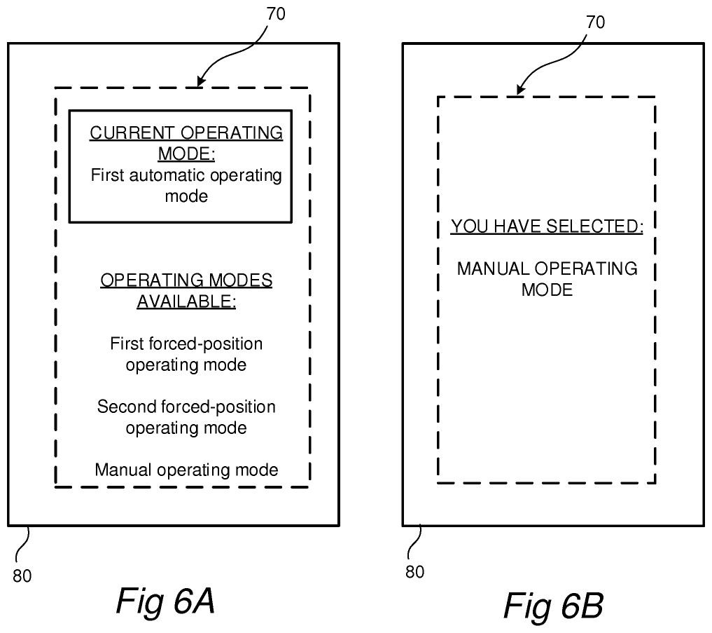

FIG. 6A-B illustrates an intelligent glass panel 70 that is integrated in a glass panel 80 arranged either at the support structure 16 or at one or more movable door members. FIG. 6A illustrates a graphical interface showing a list of virtual buttons representing different available operating modes and information regarding the current operating mode which the entrance system is working in. Although the virtual buttons are illustrated as text blocks, is should be obvious to the skilled person that the virtual buttons could have any kind of shape and appearance.

FIG. 6B illustrates the intelligent glass panel 70 directly once the user has pressed/selected one of the virtual buttons. Once the button has been pressed, the intelligent glass panel 70 shows an information box containing feedback information to the user. If the selection of operating mode has been successful, the user is informed accordingly. The information box may for example state that a change of operating mode has been initiated.

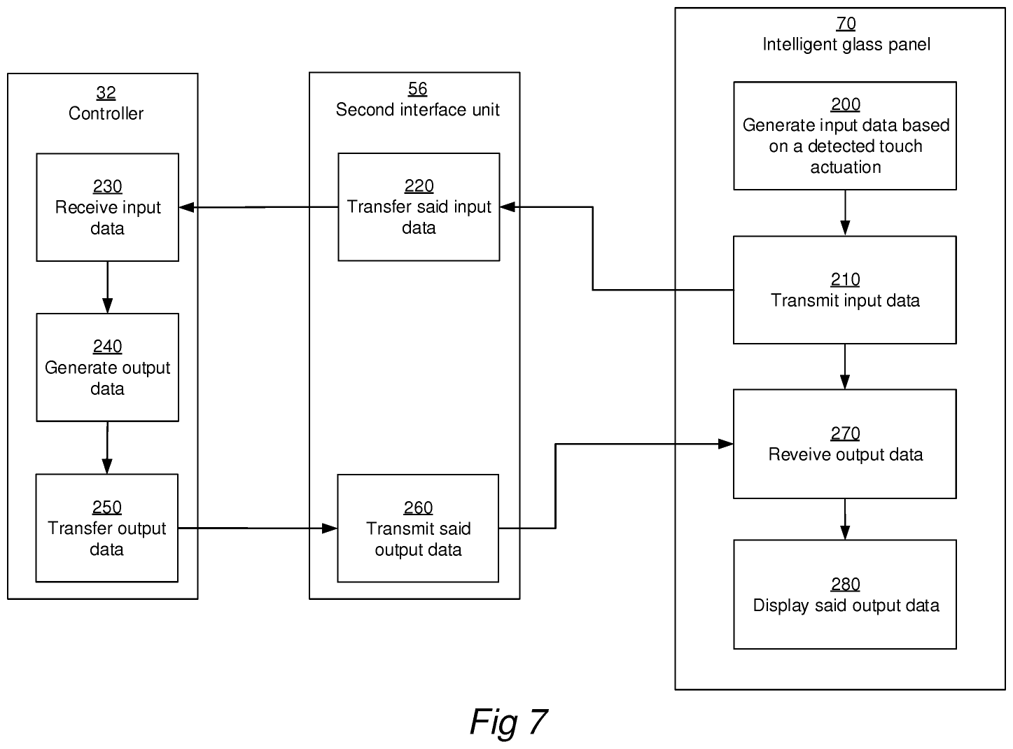

FIG. 7 illustrates a method of operating an entrance system where the user has initiated an action on the intelligent glass panel 70 in the form of pressing a virtual button in the graphical user interface on the touch sensitive display of the intelligent glass panel 70.

In a first step 200 at the intelligent glass panel 70, the intelligent glass panel 70 generates input data in response to and based on the detected touch actuation on the surface. The intelligent glass panel then transmits 210 the input data to the second interface unit 56. Preferably, the first interface unit 76 of the intelligent glass panel 70 causes the transmittal of the input data to the second interface unit 56.

In a next step, the second interface unit 56 transfer 220 the received input data to the controller 32. The controller 32 receives 230 the input data and in response to said data generates 240 output data. After generating the output data, the controller 32 transfers 250 output data to the second interface unit 56. The second interface unit 56 transmits the received output data to the intelligent glass panel 70. In a preferred embodiment, the second interface unit 56 transmits the output data to the first interface unity 76 of the intelligent glass panel 70.

The intelligent glass panel 70 receives 270 the output data and displays 280 the received output data on the intelligent glass panel 70. In this way the user gets feedback of his/her input.

The invention has been described above in detail with reference to embodiments thereof. However, as is readily understood by those skilled in the art, other embodiments are equally possible within the scope of the present invention, as defined by the appended claims.

1. An entrance system (10) comprising:
one or more movable door members (D1 . . . Dm);
a support structure (16) for supporting the one or more door members (D1 . . . Dm) for movements between closed and open positions;
an automatic door operator (30) for causing the movements of the one or more movable door members (D1 . . . Dm) between the closed and open positions; and
a control arrangement (20) comprising a controller (32) configured to control operation of the automatic door operator (30),
characterized in that
the control arrangement (20) further comprises an intelligent glass panel (70), the intelligent glass panel being integrated with any of the movable door members (D1 . . . Dm) or the support structure (16), being operatively connected with the controller (32) and being configured to act as a user interface to the entrance system (10) for a human user.

2. The entrance system as defined in claim 1, wherein the intelligent glass panel (70) comprises:
input means (72) configured for detecting touch actuation on a surface (78) of the intelligent glass panel by the user and in response producing input data;
output means (74) configured for causing presentation of output data in the intelligent glass panel; and
a first interface unit (76) configured for communicating the input data produced by the input means (72) to the controller (32) and for receiving from the controller the output data to be presented by the output means (74).

3. The entrance system as defined in claim 2, wherein the control arrangement (20) further comprises:
a second interface unit (56) coupled to the controller (32) and adapted for communicating with the first interface unit (76) of the intelligent glass panel (70),
wherein the second interface unit is configured to receive from the first interface unit (76) the input data produced by the input means (72) of the intelligent glass panel (70), and to transfer said input data to the controller (32), and
wherein the second interface unit is configured to receive from the controller (32) the output data to be presented by the output means (74) of the intelligent glass panel (70), and to transfer said output data to the first interface unit (76) of the intelligent glass panel (70).

4. The entrance system as defined in claim 3, wherein the first and second interface units (76, 56) are configured to operate in accordance with one or more short-range wireless data communication standards.

5. The entrance system as defined in claim 2, wherein the intelligent glass panel (70) comprises a touch-sensitive screen adapted to act both as said input means (72) and as said output means (74).

6. The entrance system according to claim 5, wherein the touch-sensitive screen is transparent.

7. The entrance system according to claim 6, wherein the touch-sensitive screen comprises a liquid crystal display panel configured to selectively render the intelligent glass panel (70) transparent.

8. The entrance system as defined in claim 2, wherein the input means (72) of the intelligent glass panel (70) is configured for producing input data representing one or more of the following:
a choice of a selected operating mode in which the automatic door operator (30) shall operate;
a setting of an operational parameter of the automatic door operator (30);
a reset of an alarm triggered or detected by the automatic door operator (30); and
a passcode required to execute any of the above.

9. The entrance system as defined in claim 8, wherein the output means (74) of the intelligent glass panel (70) is configured for presenting output data representing one or more of the following:
an operational status of the automatic door operator (30);
operational statistics of the entrance system (10);
an indication of a need for maintenance of repair;
an indication of an alarm triggered or detected by the automatic door operator (30);
information assisting the user for inputting the input data;
confirmation of a selected operating mode in which the automatic door operator (30) shall operate;
confirmation of a setting of an operational parameter of the automatic door operator (30); and
confirmation of a reset of an alarm triggered or detected by the automatic door operator (30).

10. The entrance system as defined in claim 1, wherein the intelligent glass panel (70) is integrated with a glass window (80) in any of the movable door members (D1 . . . Dm).

11. The entrance system as defined in claim 1, wherein the intelligent glass panel (70) is integrated with a glass window (80) in the support structure (16).

12. The entrance system as defined in, wherein the input means (72) is configured for detecting touch actuation on a second surface (75) of the intelligent glass panel (70) by the human user and in response producing input data;
whereby the intelligent glass panel (70) is integrated with any of the movable door members (D1 . . . Dm) or the support structure (16) such that the surface (78) is accessible for a human user from a first side of said movable door member (D1 . . . Dm) or said support structure (16) and the second surface (75) is accessible for a human user from a second side of said movable door member (D1 . . . Dm) or said support structure (16), the first side being opposite to the second side.

13. The entrance system as defined in claim 12, wherein the input means (72) is configured for detecting which of the first or second surface (78, 75) has been touch actuated and the output means (74) is configured for altering the presentation of output data in response to which of the first or second surface (78, 75) has been touch actuated.

14. The entrance system as defined in claim 12, wherein the output means (74) is configured for causing altering the presentation of output data by means of mirroring said output data.

15. The entrance system as defined in claim 1, wherein the intelligent glass panel (70) is integrated with any of the movable door members (D1 . . . Dm) or the support structure (16) via a frame (129) mounted to said any of the movable door members (D1 . . . Dm) or the support structure (16), whereby said frame is arranged to receive the intelligent glass panel (70).

16. The entrance system as defined in claim 1, wherein the intelligent glass panel (70) is operatively connected to the controller (32) by means of wiring (128), the controller (32) being integrated with the automatic door operator (30), whereby the wiring (128) is routed to said automatic door operator (30).

17. The entrance system as defined in claim 16, wherein the frame (129) comprises at least one aperture (136) for receiving said wiring (128).

18. The entrance system as defined in claim 16, wherein the intelligent glass panel (70) is integrated with the movable door member (D1) and the wiring is routed through said movable door member (D1) so as to be at least partially integrated into said movable door member (D1).

19. The entrance system as defined in claim 16, wherein the entrance system is in the form of a swing door system (510), the intelligent glass panel (70) being integrated with the movable door member (D1).

20. The entrance system as defined in claim 19, wherein the wiring (128) is routed to the automatic door operator (30) via a hinge arrangement (591) adapted to pivotally support said movable door member (D1).

21. The entrance system as defined in claim 19, wherein the wiring (128) is routed to the automatic door operator (30) via an arm linkage (590) connecting the automatic door operator (30) and the movable door member (D1), said arm linkage (590) being arranged to transfer torque from the automatic door operator (30) to the movable door member (D1).

22. The entrance system as defined in claim 16, wherein the entrance system is in the form of a revolving door system (610), the intelligent glass panel may be integrated with the movable door member (D1).

23. The entrance system as defined in claim 22, wherein the wiring (128) is routed to the automatic door operator (30) via a centrum shaft (691) for supporting the rotational movement of the movable door members (D1 . . . Dm).

24. The entrance system as defined in claim 16, wherein the intelligent glass panel (70) is integrated with the support structure (16) and the wiring is routed through said support structure (16) so as to be at least partially integrated into said support structure (16).
